(19) United States
(12) Patent Application Publication
(10) Pub. No.: US 2025/0298785 A1
(43) Pub. Date: Sep. 25, 2025

(54) TECHNIQUES FOR INDEXING CUSTOM-MADE COATINGS WITHIN A DATABASE

(71) Applicant: PPG INDUSTRIES OHIO, INC., Cleveland, OH (US)

(72) Inventors: Natalie Meredith Scott, Cleveland, OH (US); Allen Paul Porter, North Ridgeville, OH (US); Matthew Kevin Lynch, Cleveland, OH (US)

(73) Assignee: PPG INDUSTRIES OHIO, INC., Cleveland, OH (US)

(21) Appl. No.: 18/863,007

(22) PCT Filed: May 9, 2023
(86) PCT No.: PCT/US2023/066750

§ 371 Date: Nov. 5, 2024

Related U.S. Application Data
(60) Provisional application No. 63/364,917, filed on May 18, 2022.

(51) Int. Cl. G06F 16/22

(52) U.S. Cl. CPC G06F 16/2228

(57) ABSTRACT

A computer system for indexing custom-made coatings within a database may include processors and computer-readable media having stored thereon executable instructions. In some examples, the executable instructions may, when executed by the processors, cause the computer system to maintain a primary database including characterization data for a set of coatings (e.g., first-party coatings). The system may receive, from a user, characterization data or identifier data of a custom-made coating (e.g., a third-party coating) and may store the data in a secondary database. The computer system may then index the secondary database with the primary database such that the user may search both the primary database and the secondary database simultaneously. Accordingly, if the user performs a search, the computer system may return both first-party and third-party coatings. Such a system may provide benefits such as a more efficient workflow or a reduced search time.

### FIELD OF THE INVENTION

The present invention relates generally to coatings and more specifically to techniques for indexing custom-made coatings within a database.

### BACKGROUND OF THE INVENTION

Modern coatings provide various functions in industry and society. For example, vehicles and other types of machinery may be coated using paints or various other coatings in order to protect metal components from the elements (e.g., from rust) or to provide aesthetic visual effects. Properties of a coating (e.g., color, visual effects, texture, etc.) may be determined, in part, based on a chemical composition of the coating and may vary according to time of manufacture, geographic location (e.g., due to changes in altitude, climate, air quality, weather, etc.), or other environmental factors. In some cases, a coating mixed or used under different conditions may exhibit different visual properties when compared to another coating of the same chemical composition.

Many third-party users mix or use custom-made coatings with varied chemical composition to match properties of a target coating. The custom-made coatings may be made using information within databases of potential matching compositions and/or through variations manually entered by third-party users relying upon their own expertise. One will appreciate that the variety in resulting coating characteristics presents several technical challenges for third-party users, such as automobile repair shops, which attempt to correctly match the visual appearance of the original coating.

There are many opportunities for new methods and systems that improve the matching of coatings.

### SUMMARY OF THE INVENTION

The present invention may comprise systems, methods, or apparatus configured to index custom-made coatings within a database. In one example, the present invention may include a computer system for indexing custom-made coatings within a database including one or more processors; and one or more computer-readable media having stored thereon executable instructions. In some examples, the executable instructions may include executable instructions that when executed by the one or more processors configure the computer system to perform various acts. For example, the computer system may maintain a primary database. The primary database includes a mapping of characterization data to each coating of a set of coatings. The computer system may also receive, from a user of the computer system, characterization data and identifier data associated with a custom-made coating. The custom-made coating may not be within the set of coatings. The computer system may also store the characterization data and the identifier data associated with the custom-made coating in a secondary database. The identifier data may include a user-provided identifier for the custom-made coating and a user-provided index location. The user-provided index location may be for a location within a physical facility associated with the user of the computer system, for a physical panel coated with the custom-made coating. The computer system may index the secondary database with the primary database such that the user of the computer system can simultaneously search both the secondary database and the primary database.

In another example, the present example may include a computer-implemented method for indexing custom-made coatings within a database. The computer-implemented method may be executed on one or more processors of a computer system. The computer-implemented method may include maintaining a primary database. The primary database may include a mapping of characterization data to each coating of a set of coatings. The computer-implemented method may also include receiving, from a user of the computer system, characterization data and identifier data associated with a custom-made coating. The custom-made coating may not be within the set of coatings. The computer-implemented method may also include storing the characterization data and the identifier data associated with the custom-made coating in a secondary database. The identifier data may include a user-provided identifier for the custom-made coating and a user-provided index location, within a physical facility associated with the user of the computer system, for a physical panel coated with the custom-made coating. The method may also include indexing the secondary database with the primary database such that the user of the computer system can simultaneously search both the secondary database and the primary database.

In another example, the present invention may include a non-transitory computer-readable medium including one or more computer-readable storage media having stored thereon computer-executable instructions that, when executed at a processor, cause a computer system to perform a method for indexing custom-made coatings within a database. The method may include maintaining a primary database which includes a mapping of characterization data to each coating of a set of coatings. The method may also include receiving, from a user of the computer system, characterization data and identifier data associated with a custom-made coating. The custom-made coating may not be within the set of coatings. The method may include storing the characterization data and the identifier data associated with the custom-made coating in a second database. The identifier database may include a user-provided identifier for the custom-made coating and a user-provided index location, within a physical facility associated with the user of the computer system, for a physical panel coated with the custom-made coating. The method may also include indexing the secondary database with the primary database such that the user of the computer system can simultaneously search both the secondary database and the primary database.

Additional features and advantages of exemplary implementations of the invention will be set forth in the description which follows, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims or may be learned by the practice of such exemplary implementations as set forth hereinafter.

### BRIEF DESCRIPTION OF THE DRAWINGS

In order to describe the manner in which the above recited and other advantages and features of the invention can be obtained, a more particular description of the invention briefly described above will be rendered by reference to specific embodiments thereof, which are illustrated in the appended drawings. Understanding that these drawings depict only typical embodiments of the invention and are not therefore to be considered to be limiting of its scope, the invention will be described and explained with additional specificity and detail through the use of the accompanying drawings described below.

FIG. 1 illustrates an example of a scheme that supports techniques for indexing custom-made coatings within a database, in accordance with various aspects of the present disclosure.

FIG. 2 illustrates an example of a computer system that supports techniques for indexing custom-made coatings within a database, in accordance with various aspects of the present disclosure.

FIG. 3 illustrates an example of a computer system that supports techniques for indexing custom-made coatings with a database, in accordance with various aspects of the present disclosure.

FIG. 4 illustrates an example of a method flow that supports techniques for indexing custom-made coatings with a database, in accordance with various aspects of the present disclosure.

FIG. 5 illustrates an example of a method flow that supports techniques for indexing custom-made coatings with a database, in accordance with various aspects of the present disclosure.

### DETAILED DESCRIPTION OF THE INVENTION

The present invention extends to systems, methods, or apparatus configured to index custom-made coatings within a database. In one example, the present invention may include a computer system for indexing custom-made coatings within a database including one or more processors and one or more computer-readable media having stored thereon executable instructions. In some examples, the executable instructions may include executable instructions that when executed by the one or more processors configure the computer system to perform various functions. For example, the computer system may maintain a primary database where the primary database includes a mapping of characterization data to each coating of a set of coatings. The computer system may also receive, from a user of the computer system, characterization data and identifier data associated with a custom-made coating which is not within the set of coatings. The computer-system may store the characterization data and the identifier data associated with the custom-made coating in a secondary database. In some examples, the identifier data may include a user-provided identifier for the custom-made coating and a user-provided index location, within a physical facility associated with the user of the computer system, for a physical panel coated with the custom-made coating. The computer-system may also index the secondary database with the primary database such that the user of the computer system can simultaneously search both the secondary database and the primary database. Additionally, or alternatively, the present invention may include methods or apparatus as described herein.

Automotive shops, such as paint shops, collision repair shops, etc. may use coatings in the course of providing a variety of services, such as repair, color matching, vehicle coating, etc. For example, an automotive shop may repair collision damage on a vehicle and then may cover the affected area with a coating that matches visual properties (e.g., color, sheen, etc.) of the coating used on the rest of the vehicle. Automotive shops may employ computer systems to manage, store, mix, or otherwise create and use coatings.

For example, a set of coatings (e.g., associated information such as optical characterization data, spectrophotometric data, identifier data, etc.) may be stored in a database which may allow for searching the set of coatings for a target or matching coating. For example, information associated with the set of coatings may be retrieved from the database using software that enables a user to input search parameters for a query and view results of the query. Databases may include information associated with coatings provided by a first-party or may include information associated with custom-made coatings mixed or formulated by the automotive shop.

A user (e.g., the automotive shop) may formulate custom-made coatings if the user cannot identify a desired or target coating using a computer system. For example, the user may search a database for a target coating (e.g., a coating that matches a coating associated with a vehicle that is being repaired or recoated) using a set of parameters such as color code or other identifying information. In some cases, the computer system may return a set of coatings or variants of a coating which satisfy the given set of parameters. If the user determines that none of the returned variants sufficiently match the target coating, the user may select a coating variant which matches most closely and adjust a formulation of the coating variant to create a custom-made coating that matches the target coating. The user may store the custom-made coating in a database to allow for access if another vehicle uses the same or a similar coating. In some examples, the user may store the custom-made coating in a different database (e.g., at a physical facility of the user) than a database used by the computer system.

In some examples, an automotive shop may receive a vehicle which has been damaged, for example, in a collision. The vehicle may have mechanical, structural, or aesthetic damage. The automotive shop may repair or replace any damaged parts on the damaged vehicle using a variety of techniques. In some examples, the repairing the vehicle may include applying a new coating to be applied to part or all of the vehicle. For example, after repairing any dents, scratches, etc., the automotive repair shop may determine to apply a new coating to the damaged area such that the new coating will match the coating of the rest of the vehicle (e.g., a target coating).

The automotive shop may search a first database (e.g., a first-party database) for the target coating by, for example, entering a color code or spectrophotometric data into a computer system (e.g., running a software application which allows access to the first database), or using a spectrophotometer in communication with a computer system. The first database may be stored on a computer system local or remote to the automotive shop, or may include a book, wall, filing cabinet, etc. For example, a computer system may return identifier data which directs the automotive shop to find additional information associated with a coating in a physical book or filing cabinet provided by a first-party owner of the first database. Searching the first database may result in a set of variants which correspond to a same coating formulation or a same color code, but which differ in appearance or texture due to, for example, environmental factors such as humidity, temperature, geographic location, air pressure, elevation, etc. The automotive shop may compare each variant to the target coating to determine a closest match. For example, the automotive shop may spray out each variant coating onto a physical coating panel to compare against the target coating on the vehicle. If the automotive shop does not identify a matching coating, the automotive shop may create a custom-made coating or coating variant. For example, the automotive shop may determine that none of the variants represented in the first database has a texture which matches the target coating of the vehicle. Accordingly, the automotive shop may select a variant which most closely matches the target coating and may adjust the formula of the coating. In some examples, adjusting the formula may include incrementally changing the formula (e.g., adding or subtracting one or more components of the formula), spraying out the coating onto a physical panel and comparing the coating on the panel to the target coating on the vehicle. The automotive shop may iteratively adjust the formula to determine a matching coating.

If the automotive shop determines a matching coating, the automotive shop may store information associated with the matching coating (e.g., identifier data, color code, spectrophotometric data, an indication of how the automotive shop adjusted the formula, how many iterations were performed, a make or model of the vehicle, etc.) or the associated physical panel in a second database. For example, the automotive shop may store the physical panel in a book, in a filing cabinet, on a wall, or in another place with other custom-made coatings formulated by the automotive shop. For example, the automotive shop may keep a local database of coatings created by the automotive shop such that the automotive shop can independently track, search, or otherwise use custom coatings. In some implementations, the automotive shop may be one of a number of franchised locations and may use a database shared between all franchised locations such that each location has access to all custom coatings. In some examples, the matching coating may be stored as a variant of the color of the vehicle.

In accordance with aspects of the present disclosure, the automotive shop may enter information associated with some or all of the contents of the second database into a computer system associated with the first database (e.g., a computer system running software used to access the first database), creating a software-accessible version of the second database. The computer system may, in some examples, index the first database with the second database such that the first and second databases are searchable simultaneously. Accordingly, if the automotive shop performs a search for a target coating, the computer system may return results in both the first database and the second database (e.g., both first-party coatings and custom coatings formulated by the automotive shop).

As described herein, a computer system may index custom-made coatings (e.g., characterization or identifier data associated with the custom-made coatings) stored in a secondary database with a set of coatings stored in a primary database to realize one or more potential advantages. For example, if a third-party user uses a large number of custom-made coatings, it may be beneficial to index the custom-made coatings with a base set of coatings (e.g., first-party coatings) such that searches yield results including both custom-made coatings and the base set of coatings. Accordingly, indexing custom-made coatings with a base set of coatings may reduce a length of time required to find a desired coating if performing a database search or may reduce a system complexity due to having a single coating index instead of potentially having multiple independent sets of coatings. Additional aspects of the disclosure, including examples, advantages, etc. will be described in the context of system diagrams and method flows.

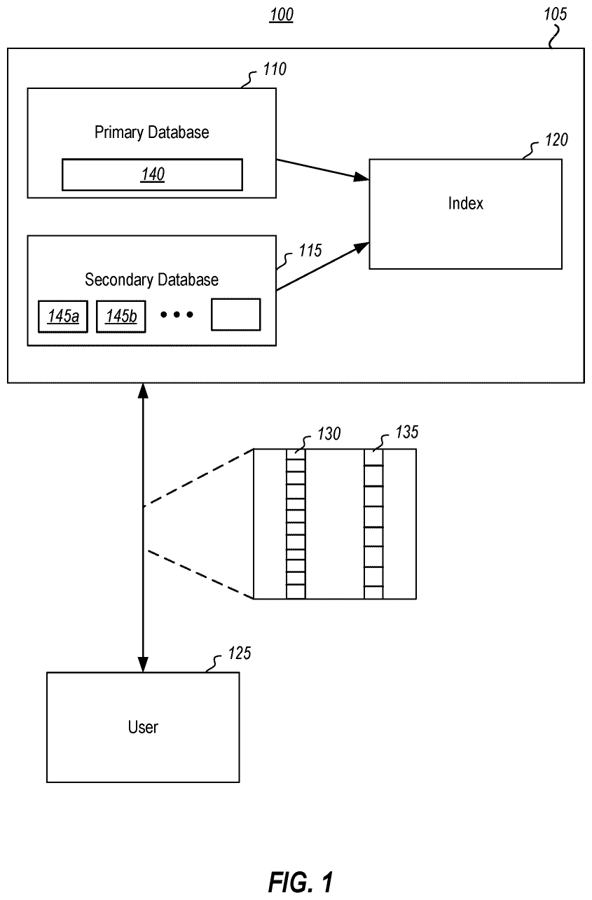

FIG. 1 illustrates an example of a scheme 100 that supports techniques for indexing custom-made coatings within a database, in accordance with various aspects of the present disclosure. The scheme 100 may include a computer system 105. The computer system 105 may include a primary database 110, a secondary database 115, and an index 120. A user computing device 125 may communicate with or otherwise use the computer system 105.

In some examples, the user computing device 125 may be associated with a third-party user (e.g., an automotive paint shop or collision repair shop) that may use the computer system 105. The user computing device 125 may search for (e.g., from a first-party or base set of coatings 140 stored in the primary database 110), record, mix, spray-out, or otherwise use coatings by utilizing the functionality of the computer system 105. For example, the user computing device 125 may desire a coating which matches a target coating used for a particular vehicle (e.g., a particular make, model, model year, trim, etc.). The user computing device 125 may use the computer system 105 to search for a coating which matches the target coating using various parameters such as color code, spectrophotometric data, etc. For example, the user computing device 125 may send, via a software application, one or more search parameters to the computer system 105 which may, using the software application, perform a database query (e.g., a structured query language (SQL) query) to the primary database 110 requesting items associated with the search parameters. The primary database 110 and the computer system 105 may return results matching or associated with the search parameters.

In some cases, the computer system 105 may return a number of different variants which are based on a single color code, but which differ in appearance. Searching the primary database 110 may result in a set of variants which correspond to a same coating formulation or color code, but which differ in appearance or texture due to, for example, environmental factors such as humidity, temperature, etc. For example, variants may be created by mixing or using a same coating formulation in different geographic locations. If the geographic locations have different climates, are at different elevations with different air pressures, etc., then the mixed coatings may have different optical or visual properties, resulting in creation of different variants.

In some examples, a user may analyze each variant to determine if the variant matches the target coating. Analyzing each variant may include creating a physical spray-out panel that is coated with the variant and manually comparing the coating variant to the target coating of the vehicle. If a matching coating is found, the user may use the user computing device 125 and the computer system 105 to mix or create the coating for use on the vehicle.

If, however, the computer system 105 does not return a matching coating, the user may create a custom-made coating, which may, in some examples, be a variant of the target coating. For example, the user may select a coating variant which most closely matches the target coating and may adjust or customize the variant by changing the formulation of the coating variant (e.g., by adjusting concentrations of different colors, textures, or other components). For each adjustment, the user may spray the custom-made coating onto a physical panel for comparing with the target coating. If the custom-made coating does not match the target coating, the user may dispose of the physical panel, formulate a new custom-made coating, and spray out the new custom-made coating on another physical panel. The user may iteratively adjust coatings until a matching coating is created. The user may use the matching coating to repair or otherwise re-coat the vehicle.

The user may use a physical panel to represent the resulting custom-made coating and may store the physical panel and/or an indication of the formula required to create the custom-made coating. Accordingly, the user may have a set of custom-made coatings within a user-specific database or indexing system that is local to the user (e.g., a wall of physical panels, a book of coating panels, a locally-stored computer database, etc.). For example, the user may store the physical panel in a book, in a filing cabinet, on a wall, or in another place with other custom-made coatings formulated by the user. In some examples, the user may keep a local database of coatings created by the user such that the user can independently track, search, or otherwise use custom coatings. In some implementations, the user may be one of a number of franchised locations and may use a database shared between all franchised locations such that each location has access to all custom coatings. Searching between the computer system 105 and the user-specific database may lead to a decreased efficiency for the user computing device 125. It may be beneficial to index the user-specific database with the base set of coatings 140.

If the user computing device 125 creates a custom-made coating, the user computing device 125 may share information associated with the custom-made coating with the computer system 105. For example, the computer system 105 may receive characterization data 130 and identifier data 135 associated with the custom-made coating, from the user computing device 125. As used herein, the characterization data 130 may include spectrophotometric data, chemical composition, a photograph or rendering of the color and/or other data. As used herein, the identifier data 135 may include a user-provided identifier such as, for example, a number, a name or reference, a color code, an associated car make, an associated car year, an associated car model, and/or a physical index location of the custom-made coating within the user's facility.

The computer system 105 may receive the characterization data 130 and the identifier data 135 and may determine that the characterization data 130 does not match characterization data associated with any coating of the base set of coatings 140 stored in the primary database 110. Accordingly, the computer system 105 may store the characterization data 130 and the identifier data 135 associated with the custom-made coating in the secondary database 115. Accordingly, the secondary database 115 may include one or more custom-made coatings 145 which may or may not have any association. For example, the secondary database 115 may include a custom-made coating 145a and a custom-made coating 145b which may be associated with different color codes, vehicles, etc. The computer system 105 may then index the primary database 110 and the secondary database 115 in the index 120. The computer system 105 may create an index 120 of the base set of coatings 140 and each custom-made coating 145 such that contents of the primary database 110 and the secondary database 115 may be searched or changed simultaneously. Accordingly, if the user computing device 125 sends the computer system 105 a query for a target coating, the computer system 105 may search the primary database 110 and the secondary database 115 based on the index 120 such that the computer system 105 returns, to the user computing device 125, coatings which may be from the primary database 110 or the secondary database 115. For example, the user computing device 125 may request a search for a target coating associated with both first-party and custom variants stored in the primary database 110 and the secondary database 115, respectively. In such an example, the user computing device 125 may use the index 120 to search both the primary database 110 and the secondary database 115 and may return, to the user computing device 125 results from both the primary database 110 and the secondary database 115. Similarly, the computer system 105 may return results from only one of the primary database 110 or the secondary database 115 if no first-party or custom coatings or variants are associated with search parameters associated with a target coating provided by the user computing device 125. In some examples, if the secondary database 115 is associated with multiple franchised locations, the computer system 105 may return results from different franchised locations. In such examples, the computer system 105 may also provide an indication of a franchised location with which a coating or coating panel is associated. In some implementations, the user computing device 125 may desire to search only the primary database 110 or the secondary database 115 and so may provide an indication to the computer system 105 of a database in which to perform a search. In such implementations, the computer system 105 may search only the indicated database.

In some implementations, the primary database 110 and the secondary database 115 may be physically separate (e.g., stored on different computer systems) or may be stored separately on a same computer system (e.g., may be stored on different storage volumes, as different databases on one storage medium, etc.) or may be otherwise differentiated (e.g., may use different identifiers, flags, etc.). In some examples, the secondary database 115 may be stored local to a third-party and the primary database 110 may be stored remotely (e.g., at a datacenter maintained or leased by a first-party). Alternatively, the primary database 110 and the secondary database 115 may both be stored either locally or remotely to the third-party. In some examples, if the third-party is one of a number of franchised locations, the secondary database 115 may be stored on a database server shared between all franchised locations while the primary database 110 may be stored or managed by a first-party not associated with the franchised locations. In some implementations, the primary database 110 or the secondary database 115 may use one or more database technologies. For example, the primary database 110 or the secondary database 115 may be relational or non-relational databases, cloud databases, hierarchical databases, graph databases, etc., which use associated database managers.

Different data storage schemes for the primary database 110 and the secondary database 115 may satisfy data integrity or privacy thresholds. For example, an automotive paint shop may desire to maintain privacy of the secondary database 115 to prevent unauthorized access of the included coating data. If a paint shop includes multiple franchised locations, the paint shop may store the secondary database 115 at a centralized location such that each franchised location may access the secondary database 115. In some examples, a first party may have read/write access to the primary database 110 and the secondary database 115 but a third party may have read/write access to only the secondary database 115. In some implementations, a first party user may not have access to the secondary database 115. In some examples, a first party user may have access to analyze, correct, compare, or otherwise use data stored in the secondary database 115. In some examples, a third-party entity may determine that any custom variants produced by the third-party entity are to be kept confidential and so may store a confidentiality indicator in the secondary database 115. If the secondary database 115 includes a confidentiality indicator, the computer system 105 may prevent all other entities, including a first-party entity, from accessing the contents of the secondary database 115. It is noted that other data storage schemes than the ones described herein may be utilized to satisfy privacy or security thresholds as desired by different entities associated with or which use the primary database 110 or the secondary database 115.

Accordingly, if the user computing device 125 performs a search for a coating (e.g., using a color code, spectrophotometric data, chemical composition, etc.) the computer system 105 may return results from both the primary database 110 and the secondary database 115, using the index 120. In some examples, the computer system 105 may display the results using a set of digital images which represent a number of viewing angles (e.g., a face angle, a flop angle, a flash angle, or combination thereof). In some examples, the secondary database 115 may be associated with physical representations of the coatings (e.g., physical spray-out panels) and the primary database 110 may not. Similarly, in some examples, the primary database 110 or the secondary database 115 may or may not include digital images of one or more coatings. For example, the primary database 110 may include digital images but the secondary database 115 may not include digital images. If the primary database 110 or the secondary database 115 does not include digital images, then a search may return characterization data or identifier data without image representations. Similarly, the primary database 110 and the secondary database 115 may each include spectrophotometric data associated with coatings stored therein but may store different identifier data, indices, etc., associated with the coatings. For example, the secondary database 115 may store indices corresponding to a physical database (e.g., a book, a filing cabinet, a wall, etc.) local to a third party user of the computer system 105 but the primary database 110 may not have any such indices associated with a physical database. As such, the primary database 110 and the secondary database may differ in types of data stored in association with coatings.

In some examples, the computer system 105 may determine a validity of the characterization data 130. For example, the computer system 105 may determine whether the characterization data 130 satisfies an accuracy threshold, a precision threshold, or a popularity threshold (e.g., may determine whether the custom-made coating matches the specified vehicle, is in wide use, etc.). For example, the computer system 105 may compare the characterization data 130 to characterization data received from other third-parties associated with a same color code, a same vehicle type (e.g., make, model, etc.), etc. Comparing data from multiple sources may allow the computer system 105 to determine whether or not the characterization data 130 is accurate or consistent with data from other sources. Additionally, or alternatively, the computer system 105 may use artificial intelligence, machine learning, or other algorithmic approaches to analyze or otherwise determine the validity of the characterization data 130. For example, the computer system 105 may use historical data associated with custom variants (e.g., including custom variants that were accepted as valid) to train a machine learning model that is able to predict or otherwise determine whether new variants are or will be in wide use or valid.

In some examples, the computer system 105 may analyze the secondary database 115 and determine that a coating is associated with a large number of custom variants or may determine that a large number of third-party entities adjusted a coating variant in a similar way (e.g., all added a certain texture, color, etc.). In such examples, the computer system 105 may issue a notification to a first party user indicating the existence of a large number of custom variants or may analyze the variants to determine whether the variants are valid or, for example, satisfy a consistency threshold. In some implementations, a consistency threshold may correspond to a number of third-party entities which all create a same or substantially similar custom variant for a vehicle. If a sufficiently large number of third-party entities created a same or substantially similar custom variant of a color, a first-party user may determine that the custom variant is valid.

In some implementations, the computer system 105 may receive an indication of validity from one or more users of the computer system 105 such as first-party workers, scientists, quality assurance technicians, etc. (e.g., which have validated the data independent of the computer system 105). For example, a first-party user may determine that a custom variant has been created or used by a number of third-party entities and so may analyze different versions of the custom variant (e.g., the custom variant as formulated by a number of different third-party users) to see that the formulae used are consistent, would provide the expected results, etc. (e.g., may determine that the variant is valid). If the first-party user determines that the variant is valid, the first-party user may notify the computer system 105 of the validity. If the computer system 105 determines that the characterization data 130 is valid, the computer system 105 may store the characterization data 130 in the primary database 110 (e.g., may add the custom-made coating to the base set of coatings 140).

In some examples, adding the characterization data 130 to the primary database 110 may include adjusting the characterization data 130 to align with the other contents of the primary database 110. For example, the computer system 105 may adjust indices, identifier data, color codes, digital images, etc., to correspond to a standard format used by the other contents of the primary database 110. For example, if characterization data 130 or the identifier data 135 include information specific to the third-party user that created the custom coating or coating variant, the computer system 105 may remove the information if including the characterization data 130 or the identifier data 135 in the primary database 110. If added to the primary database 110, the characterization data 130 (e.g., and the associated coating) may be made available for use by all potential third-party entities. Implementing various aspects of the scheme 100 may reduce a length of time required to find a desired coating if performing a database search or may reduce a system complexity due to having a single coating index instead of potentially having multiple independent sets of coatings, which may lead to a more efficient workflow, or a more efficient resource utilization, among other benefits.

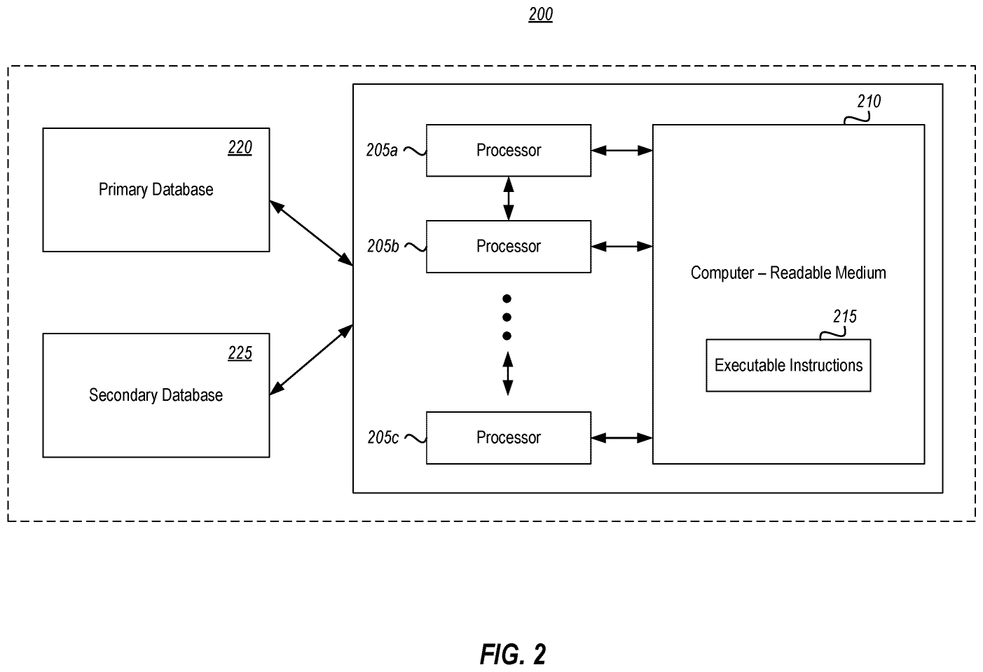

FIG. 2 illustrates an example of a computer system 200 that supports techniques for indexing custom-made coatings within a database, in accordance with various aspects of the present disclosure. The computer system 200 may implement aspects of a scheme 100 as described with reference to FIG. 1. The computer system 200 may include one or more processors 205 (e.g., a processor 205a, a processor 205b, a processor 205c, etc.), a computer-readable medium 210 and a set of executable instructions 215. In some examples, the computer system 200 may also include a primary database 220 and a secondary database 225. The one or more processors 205 may include general purpose processors, central processing units, graphics processing units, digital signal processors, application specific integrated circuits, field-programmable gate arrays, or any combination thereof. The primary database 220 and the secondary database 225 may communicate with the processors 205 via any transmission network such wired or wireless networks as well as connections such as peripheral component interconnect express (PCI-e), serial AT attachment protocols, small computer system interface (SCSI) or similar technologies. In some examples, the primary database 220 and the secondary database 225 may be in a same or different geographic locations (e.g., may be local or remote relative to other components of the computer system 200). The computer system 200 may be an example of means for performing methods and functions of the present disclosure as described herein.

For example, the set of executable instructions 215 may include instructions which, when executed by the one or more processors 205, may cause the computer system 200 to perform the following: maintain a primary database, the primary database comprising a mapping of characterization data to each coating of a set of coatings; receive, from a user of the computer system 200, characterization data and identifier data associated with a custom-made coating, wherein the custom-made coating is not within the set of coatings; store the characterization data and the identifier data associated with the custom-made coating in a secondary database, wherein the identifier data comprises: a user-provided identifier for the custom-made coating, and a user-provided index location, within a physical facility associated with the user of the computer system, for a physical panel coated with the custom-made coating; and index the secondary database with the primary database such that the user of the computer system 200 can simultaneously search both the secondary database and the primary database. Implementing various aspects of the computer system 200 may lead to an increased efficiency of database searches, a more efficient workflow, or a more efficient resource utilization, among other benefits.

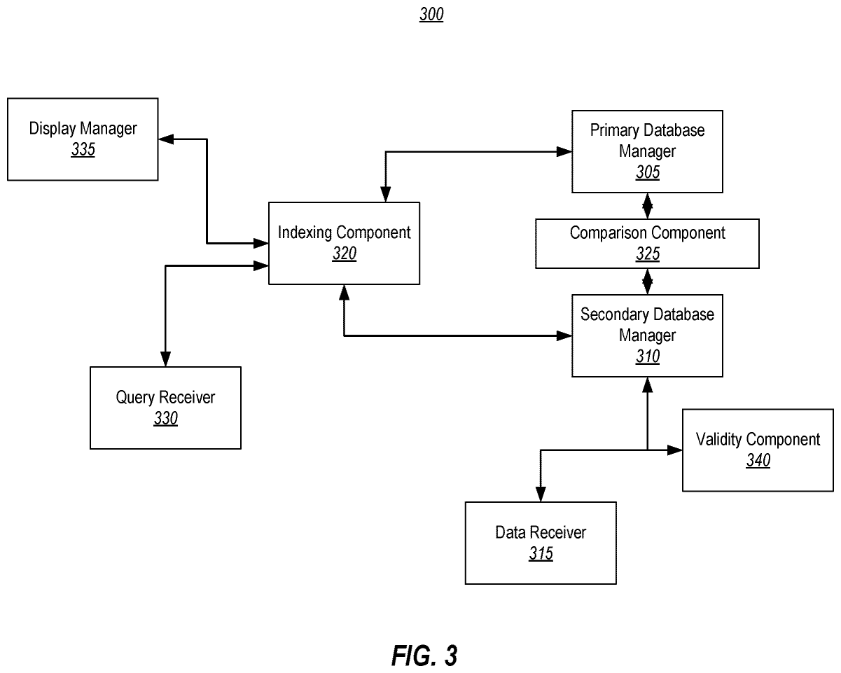

FIG. 3 illustrates an example of a computer system 300 that supports techniques for indexing custom-made coatings with a database, in accordance with various aspects of the present disclosure. In some examples, the computer system 300 may implement aspects of a scheme 100 or a computer system 200 as described with reference to FIGS. 1 and 2. For example, the computer system 300 may be implemented by one or more processors or one or more computer-readable media as described herein. The computer system 300 may include a primary database manager 305, a secondary database manager 310, a data receiver 315, an indexing component 320, a comparison component 325, a query receiver 330, a display manager 335, and a validity component 340. The components of the computer system 300 as described herein may communicate or otherwise share information as illustrated in FIG. 3 or in other ways, such as between components not illustrated. In some example, the computer system 300 may include additional components or components may be removed or altered. The computer system 300 may be an example of means for performing methods and functions of the present disclosure as described herein.

The primary database manager 305 may maintain a primary database, the primary database including a mapping of characterization data to each coating of a set of coatings (e.g., a set of first-party coatings as defined by the computer system 300).

The data receiver 315 may receive, from a user of the computer system 300 or from a user computing device, characterization data and identifier data associated with a custom-made coating (e.g., a third-party coating), in which the custom-made coating is not within the set of coatings. The secondary database manager 310 may store the characterization data and the identifier data associated with the custom-made coating in a secondary database. In some examples, the secondary database may be separate from the first database. In some examples, the comparison component 325 may determine that the characterization data associated with the custom-made coating is different from the characterization data mapped to each coating of the set of coatings.

In some examples, the identifier data may include a user-provided identifier for the custom-made coating, and a user-provided index location, within a physical facility associated with the user of the computer system 300, for a physical panel coated with the custom-made coating. In some example, the characterization data may include an optical characterization (e.g., spectrophotometric data) of the custom-made coating. In some implementations, the custom-made coating may include a spray-out panel produced by the user of the computer system 300. In some examples, the custom-made coating may be associated with a type of vehicle such that the characterization data associated with the custom-made coating includes an indication of the type of vehicle.

In some examples, the validity component 340 may determine whether the characterization data associated with the custom-made coating satisfies a validity condition. In such examples, the primary database manager 305 may store the characterization data associated with the custom-made coating in the primary database. In some implementations, may include an accuracy threshold, a precision threshold, a popularity threshold, or any combination thereof. In some implementations, the validity component 340 may receive, from one or more users of the computer system 300, an indication that the characterization data associated with the custom-made coating satisfies the validity condition.

The indexing component 320 may index the secondary database with the primary database such that the user of the computer system 300 can simultaneously search both the secondary database and the primary database. In some examples, the query receiver 330 may receive, from the user of the computer system 300, a query for a coating which satisfies one or more requirements provided by the user of the computer system. In some implementations, the query may include a color code or spectrophotometric data. In some examples, the display manager 335 may display, to the user of the computer system 300, one or more coatings from the primary database and the secondary database which satisfy at least one of the one or more requirements, in which displaying the one or more coatings is based on indexing the secondary database with the primary database. In some implementations, the display manager 335 may display, to the user of the computer system, one or more digital images associated with the one or more coatings, the one or more digital images including a face angle, a flop angle, a flash angle, or any combination thereof. Implementing various aspects of the computer system 300 may lead to an increased efficiency of database searches, a more efficient workflow, or a more efficient resource utilization, among other benefits.

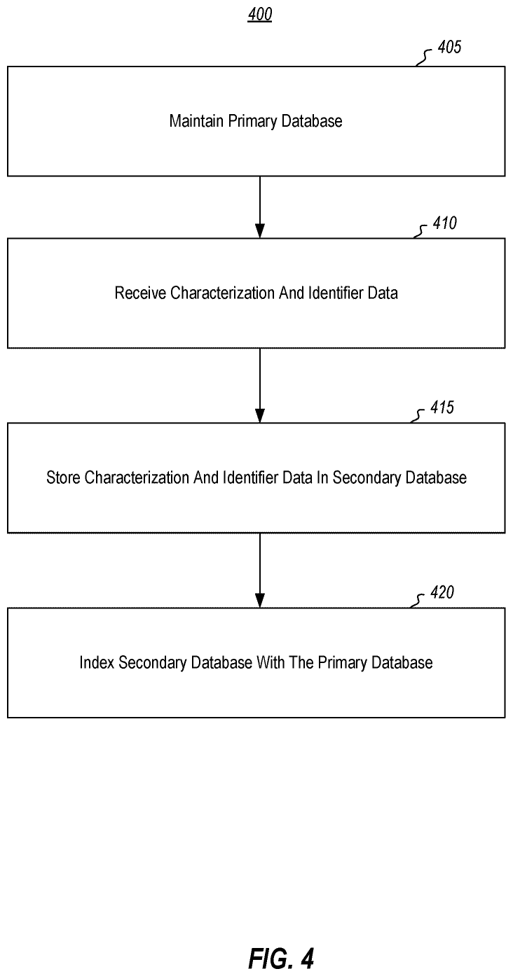

FIG. 4 illustrates an example of a method flow 400 that supports techniques for indexing custom-made coatings with a database, in accordance with various aspects of the present disclosure. In some examples, the method flow 400 may be implemented by aspects of a scheme 100, a computer system 200, or a computer system 300 as described with reference to FIGS. 1-3. For example, the method flow 400 may be implemented by a computer system including one or more processors or may be associated with executable instructions stored in computer-readable media which cause the computer system to perform the steps of the method flow 400. It is noted that, in some examples, steps of the method flow 400 may be performed in a different order than illustrated or steps may be added or removed.

At 405, the method flow 400 may include maintaining a primary database, the primary database including a mapping of characterization data to each coating of a set of coatings.

At 410, the method flow 400 may include receiving, from a user of the computer system, characterization data and identifier data associated with a custom-made coating, in which the custom-made coating is not within the set of coatings.

At 415, the method flow 400 may include storing the characterization data and the identifier data associated with the custom-made coating in a secondary database. In some examples, the identifier data may include a user-provided identifier for the custom-made coating, and a user-provided index location, within a physical facility associated with the user of the computer system, for a physical panel coated with the custom-made coating.

At 420, the method flow 400 may include indexing the secondary database with the primary database such that the user of the computer system can simultaneously search both the secondary database and the primary database. Implementing various aspects of the method flow 400 may lead to an increased efficiency of database searches or a more efficient resource utilization, among other benefits.

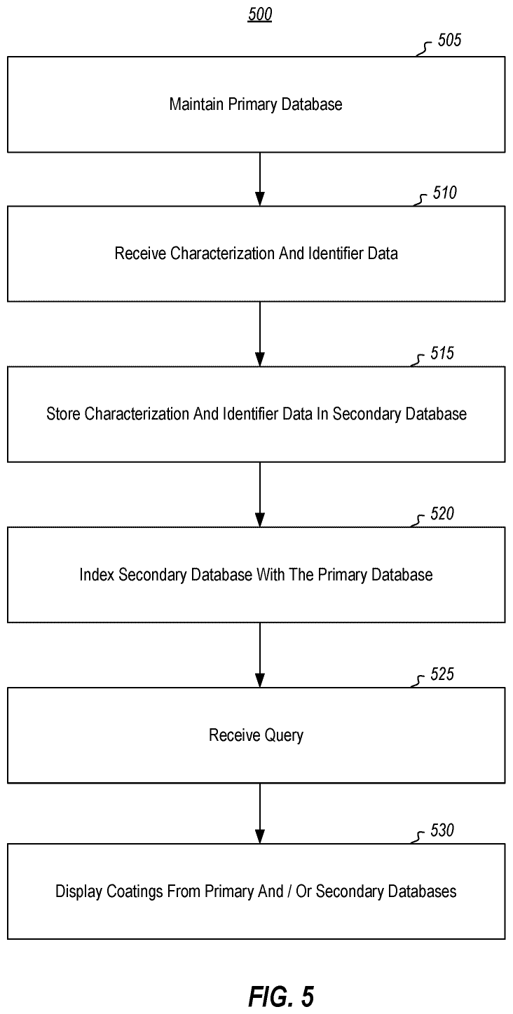

FIG. 5 illustrates an example of a method flow 500 that supports techniques for indexing custom-made coatings with a database, in accordance with various aspects of the present disclosure. In some examples, the method flow 500 may be implemented by aspects of a scheme 100, a computer system 200, or a computer system 300 as described with reference to FIGS. 1-3. For example, the method flow 500 may be implemented by a computer system including one or more processors or may be associated with executable instructions stored in computer-readable media which cause the computer system to perform the steps of the method flow 500. It is noted that, in some examples, steps of the method flow 500 may be performed in a different order than illustrated or steps may be added or removed.

At 505, the method flow 500 may include maintaining a primary database, the primary database including a mapping of characterization data to each coating of a set of coatings.

At 510, the method flow 500 may include receiving, from a user of the computer system, characterization data and identifier data associated with a custom-made coating, in which the custom-made coating is not within the set of coatings.

At 515, the method flow 500 may include storing the characterization data and the identifier data associated with the custom-made coating in a secondary database. In some examples, the identifier data may include a user-provided identifier for the custom-made coating, and a user-provided index location, within a physical facility associated with the user of the computer system, for a physical panel coated with the custom-made coating.

At 520, the method flow 500 may include indexing the secondary database with the primary database such that the user of the computer system can simultaneously search both the secondary database and the primary database.

At 525, the method flow 500 may include receiving, from the user of the computer system, a query for a coating which satisfies one or more requirements provided by the user of the computer system.

At 530, the method flow 500 may include displaying, to the user of the computer system, one or more coatings from the primary database and the secondary database which satisfy at least one of the one or more requirements, in which displaying the one or more coatings may be based on indexing the secondary database with the primary database. Implementing various aspects of the method flow 500 may lead to an increased efficiency of database searches or a more efficient resource utilization, among other benefits.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

The present invention may comprise or utilize a special-purpose or general-purpose computer system that includes computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general-purpose or special-purpose computer system. Computer-readable media (e.g., non-transitory computer-readable media) that store computer-executable instructions and/or data structures are computer storage media. Computer-readable media that carry computer-executable instructions and/or data structures are transmission media. Thus, by way of example, and not limitation, embodiments of the invention can comprise at least two distinctly different kinds of computer-readable media: computer storage media and transmission media.

Computer storage media are physical storage media that store computer-executable instructions and/or data structures. Physical storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud-computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud-computing model can be composed of various characteristics, such as on-demand self-service, broad network access, resource pooling, rapid elasticity, measured service, and so forth. A cloud-computing model may also come in the form of various service models such as, for example, Software as a Service (“SaaS”), Platform as a Service (“PaaS”), and Infrastructure as a Service (“laaS”). The cloud-computing model may also be deployed using different deployment models such as private cloud, community cloud, public cloud, hybrid cloud, and so forth.

Some embodiments, such as a cloud-computing environment, may comprise a system that includes one or more hosts that are each capable of running one or more virtual machines. During operation, virtual machines emulate an operational computing system, supporting an operating system and perhaps one or more other applications as well. In some embodiments, each host includes a hypervisor that emulates virtual resources for the virtual machines using physical resources that are abstracted from view of the virtual machines. The hypervisor also provides proper isolation between the virtual machines. Thus, from the perspective of any given virtual machine, the hypervisor provides the illusion that the virtual machine is interfacing with a physical resource, even though the virtual machine only interfaces with the appearance (e.g., a virtual resource) of a physical resource. Examples of physical resources including processing capacity, memory, disk space, network bandwidth, media drives, and so forth.

The present invention is further described according to the following examples:
Example 1: A computer system for indexing custom-made coatings within a database is provided, comprising: one or more processors; and one or more computer-readable media having stored thereon executable instructions that when executed by the one or more processors configure the computer system to perform at least the following: maintain a primary database, the primary database comprising a mapping of characterization data to each coating of a set of coatings; receive, from a user of the computer system, characterization data and identifier data associated with a custom-made coating, wherein the custom-made coating is not within the set of coatings; store the characterization data and the identifier data associated with the custom-made coating in a secondary database, wherein the identifier data comprises: a user-provided identifier for the custom-made coating, and a user-provided index location, within a physical facility associated with the user of the computer system, for a physical panel coated with the custom-made coating; and index the secondary database with the primary database such that the user of the computer system can simultaneously search both the secondary database and the primary database.
Example 2: The computer system of example 1, the executable instructions include instructions that are executable to configure the computer system to: receive, from the user of the computer system, a query for a coating which satisfies one or more requirements provided by the user of the computer system; and display, to the user of the computer system, one or more coatings from the primary database and the secondary database which satisfy at least one of the one or more requirements, wherein displaying the one or more coatings is based at least in part on indexing the secondary database with the primary database.
Example 3: The computer system of any of examples 1 or 2, in which the executable instructions include instructions that are executable to configure the computer system to display, to the user of the computer system, one or more digital images associated with the one or more coatings, the one or more digital images including a face angle, a flop angle, a flash angle, or any combination thereof.
Example 4: The computer system of any of examples 2 or 3, in which the query comprises a color code or spectrophotometric data.
Example 5: The computer system of any of examples 1 to 4, in which the secondary database is separate from the primary database.
Example 6: The computer system of any of examples 1 to 5, in which the executable instructions include instructions that are executable to configure the computer system to determine that the characterization data associated with the custom-made coating is different from the characterization data mapped to each coating of the set of coatings.
Example 7: The computer system of any of examples 1 to 6, in which the characterization data comprises an optical characterization of the custom-made coating (such as optical characterization data).
Example 8: The computer system of any of examples 1 to 7, in which the optical characterization comprises spectrophotometric data.
Example 9: The computer system of any of examples 1 to 8, in which the custom-made coating comprises a spray-out panel produced by the user of the computer system.
Example 10: The computer system of any of examples 1 to 9, in which the custom-made coating is associated with a type of vehicle, and the characterization data associated with the custom-made coating comprises an indication of the type of vehicle.
Example 11: The computer system of any of examples 1 to 10, in which the executable instructions include instructions that are executable to configure the computer system to: determine whether the characterization data associated with the custom-made coating satisfies a validity condition; and store the characterization data associated with the custom-made coating in the primary database.
Example 12: The computer system of any of examples 1 to 11, in which the validity condition comprises an accuracy threshold, a precision threshold, a popularity threshold, or any combination thereof.
Example 13: The computer system of any of examples 11 or 12, in which the executable instructions include instructions that are executable to configure the computer system to receive, from one or more users of the computer system, an indication that the characterization data associated with the custom-made coating satisfies the validity condition.
Example 14: The computer system of any of examples 1 to 13, in which spectrophotometric data, an indication of how the automotive shop adjusted the formula, environmental factors such as humidity, temperature, geographic location, air pressure, or elevation, or how many iterations were performed associated with the custom-made coating are additionally stored in a secondary database.
Example 15: A computer-implemented method for indexing custom-made coatings within a database is provided, preferably using the computer system according to any one of clauses one to fourteen, the computer-implemented method executed on one or more processors of a computer system, the computer-implemented method comprising: maintaining a primary database, the primary database comprising a mapping of characterization data to each coating of a set of coatings; receiving, from a user of the computer system, characterization data and identifier data associated with a custom-made coating, wherein the custom-made coating is not within the set of coatings; storing the characterization data and the identifier data associated with the custom-made coating in a secondary database, wherein the identifier data comprises: a user-provided identifier for the custom-made coating, and a user-provided index location, within a physical facility associated with the user of the computer system, for a physical panel coated with the custom-made coating; and indexing the secondary database with the primary database such that the user of the computer system can simultaneously search both the secondary database and the primary database.
Example 16: The computer-implemented method of example 15, in which the computer-implemented method further comprises: receiving, from the user of the computer system, a query for a coating which satisfies one or more requirements provided by the user of the computer system; and displaying, to the user of the computer system, one or more coatings from the primary database and the secondary database which satisfy at least one of the one or more requirements, wherein displaying the one or more coatings is based at least in part on indexing the secondary database with the primary database.
Example 17: The computer-implemented method of any of examples 15 or 16, in which the computer-implemented method further comprises displaying, to the user of the computer system, one or more digital images associated with the one or more coatings, the one or more digital images including a face angle, a flop angle, a flash angle, or any combination thereof.
Example 18: The computer-implemented method of any of examples 15 to 17, in which the computer-implemented method further comprises determining that the characterization data associated with the custom-made coating is different from the characterization data mapped to each coating of the set of coatings.
Example 19: The computer-implemented method of any of examples 15 to 18, in which the computer-implemented method further comprises determining whether the characterization data associated with the custom-made coating satisfies a validity condition; and store the characterization data associated with the custom-made coating in the primary database.
Example 20: A non-transitory computer-readable medium comprising one or more computer-readable storage media having stored thereon computer-executable instructions is provided, preferably using the computer system according to any one of clauses one to fourteen and/or the method according to any one of clauses fifteen to nineteen, that when executed at a processor, cause a computer system to perform a method for indexing custom-made coatings within a database, the method comprising: maintaining a primary database, the primary database comprising a mapping of characterization data to each coating of a set of coatings; receiving, from a user of the computer system, characterization data and identifier data associated with a custom-made coating, wherein the custom-made coating is not within the set of coatings; storing the characterization data and the identifier data associated with the custom-made coating in a secondary database, wherein the identifier data comprises: a user-provided identifier for the custom-made coating, and a user-provided index location, within a physical facility associated with the user of the computer system, for a physical panel coated with the custom-made coating; and indexing the secondary database with the primary database such that the user of the computer system can simultaneously search both the secondary database and the primary database.
Example 21: The non-transitory computer-readable medium of example 20, in which the computer-executable instructions further comprise computer-executable instructions that, when executed at a processor, cause the computer system to perform the following: receiving, from the user of the computer system, a query for a coating which satisfies one or more requirements provided by the user of the computer system; and displaying, to the user of the computer system, one or more coatings from the primary database and the secondary database which satisfy at least one of the one or more requirements, wherein displaying the one or more coatings is based at least in part on indexing the secondary database with the primary database.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1-20. (cancelled)

21. A computer system for indexing custom-made coatings within a database, comprising:
one or more processors; and
one or more computer-readable media having stored thereon executable instructions that when executed by the one or more processors configure the computer system to perform at least the following:
maintain a primary database, the primary database comprising a mapping of characterization data to each coating of a set of coatings;
receive, from a user of the computer system, characterization data and identifier data associated with a custom-made coating, wherein the custom-made coating is not within the set of coatings;
store the characterization data and the identifier data associated with the custom-made coating in a secondary database, wherein the identifier data comprises:
a user-provided identifier for the custom-made coating, and
a user-provided index location, within a physical facility associated with the user of the computer system, for a physical panel coated with the custom-made coating; and
index the secondary database with the primary database such that the user of the computer system can simultaneously search both the secondary database and the primary database.

22. The computer system of claim 21, wherein the executable instructions include instructions that are executable to configure the computer system to:
receive, from the user of the computer system, a query for a coating which satisfies one or more requirements provided by the user of the computer system; and
display, to the user of the computer system, one or more coatings from the primary database and the secondary database which satisfy at least one of the one or more requirements, wherein displaying the one or more coatings is based at least in part on indexing the secondary database with the primary database.

23. The computer system of claim 22, wherein the executable instructions include instructions that are executable to configure the computer system to display, to the user of the computer system, one or more digital images associated with the one or more coatings, the one or more digital images including a face angle, a flop angle, a flash angle, or any combination thereof.

24. The computer system of claim 22, wherein the query comprises a color code or spectrophotometric data.

25. The computer system of claim 21, wherein the secondary database is separate from the primary database.

26. The computer system of claim 21, wherein the executable instructions include instructions that are executable to configure the computer system to determine that the characterization data associated with the custom-made coating is different from the characterization data mapped to each coating of the set of coatings.

27. The computer system of claim 21, wherein the characterization data comprises an optical characterization of the custom-made coating.

28. The computer system of claim 27, wherein the optical characterization comprises spectrophotometric data.

29. The computer system of claim 21, wherein the custom-made coating comprises a spray-out panel produced by the user of the computer system.

30. The computer system of claim 21, wherein:
the custom-made coating is associated with a type of vehicle, and
the characterization data associated with the custom-made coating comprises an indication of the type of vehicle.

31. The computer system of claim 21, wherein the executable instructions include instructions that are executable to configure the computer system to:
determine whether the characterization data associated with the custom-made coating satisfies a validity condition; and
store the characterization data associated with the custom-made coating in the primary database.

32. The computer system of claim 31, wherein the validity condition comprises an accuracy threshold, a precision threshold, a popularity threshold, or any combination thereof.

33. The computer system of claim 31, wherein the executable instructions include instructions that are executable to configure the computer system to receive, from one or more users of the computer system, an indication that the characterization data associated with the custom-made coating satisfies the validity condition.

34. A computer-implemented method for indexing custom-made coatings within a database, the computer-implemented method executed on one or more processors of a computer system, the computer-implemented method comprising:
maintaining a primary database, the primary database comprising a mapping of characterization data to each coating of a set of coatings;
receiving, from a user of the computer system, characterization data and identifier data associated with a custom-made coating, wherein the custom-made coating is not within the set of coatings;
storing the characterization data and the identifier data associated with the custom-made coating in a secondary database, wherein the identifier data comprises:
a user-provided identifier for the custom-made coating, and
a user-provided index location, within a physical facility associated with the user of the computer system, for a physical panel coated with the custom-made coating; and
indexing the secondary database with the primary database such that the user of the computer system can simultaneously search both the secondary database and the primary database.

35. The computer-implemented method of claim 34, further comprising:
receiving, from the user of the computer system, a query for a coating which satisfies one or more requirements provided by the user of the computer system; and
displaying, to the user of the computer system, one or more coatings from the primary database and the secondary database which satisfy at least one of the one or more requirements, wherein displaying the one or more coatings is based at least in part on indexing the secondary database with the primary database.

36. The computer-implemented method of claim 35, further comprising displaying, to the user of the computer system, one or more digital images associated with the one or more coatings, the one or more digital images including a face angle, a flop angle, a flash angle, or any combination thereof.

37. The computer-implemented method of claim 34, further comprising determining that the characterization data associated with the custom-made coating is different from the characterization data mapped to each coating of the set of coatings.

38. The computer-implemented method of claim 34, further comprising:
determining whether the characterization data associated with the custom-made coating satisfies a validity condition; and
store the characterization data associated with the custom-made coating in the primary database.

39. A non-transitory computer-readable medium comprising one or more computer-readable storage media having stored thereon computer-executable instructions that, when executed at a processor, cause a computer system to perform a method for indexing custom-made coatings within a database, the method comprising:
maintaining a primary database, the primary database comprising a mapping of characterization data to each coating of a set of coatings;
receiving, from a user of the computer system, characterization data and identifier data associated with a custom-made coating, wherein the custom-made coating is not within the set of coatings;
storing the characterization data and the identifier data associated with the custom-made coating in a secondary database, wherein the identifier data comprises:
a user-provided identifier for the custom-made coating, and
a user-provided index location, within a physical facility associated with the user of the computer system, for a physical panel coated with the custom-made coating; and
indexing the secondary database with the primary database such that the user of the computer system can simultaneously search both the secondary database and the primary database.

40. The non-transitory computer-readable medium of claim 39, wherein the computer-executable instructions further comprise computer-executable instructions that, when executed at a processor, cause the computer system to perform the following:
receiving, from the user of the computer system, a query for a coating which satisfies one or more requirements provided by the user of the computer system; and
displaying, to the user of the computer system, one or more coatings from the primary database and the secondary database which satisfy at least one of the one or more requirements, wherein displaying the one or more coatings is based at least in part on indexing the secondary database with the primary database.
